(19) United States
(12) Patent Application Publication
(10) Pub. No.: US 2007/0245402 A1
(43) Pub. Date: Oct. 18, 2007

(54) Method and apparatus of recording information on and reproducing information from a recording medium

(76) Inventor: Han Suk Kim, Yongin-si (KR)

Correspondence Address: KED & ASSOCIATES, LLP, P.O. Box 221200, Chantilly, VA, 20153-1200, US

(21) Appl. No.: 11/701,505

(22) Filed: Feb. 2, 2007

(30) Foreign Application Priority Data
Apr. 18, 2006 (KR) 10-2006-0034812

(51) Int. Cl. H04L 9/32; G11B 5/09

(52) U.S. Cl. 726/2; 369/59.24

(57) ABSTRACT

A method and apparatus for recording information generates an encryption key based on a user password, encrypts user-selected data using the encryption key, and records the encrypted data on the medium. The information may then be read and reproduced from the medium using another disk drive, including one which does not have prior access to decryption software compatible with the data on the medium. The information is reproduced by reading the decryption program from the disk, generating an encryption key based on an input user password using the decryption program, and then decrypting the user-selected data using the key. Through this method the encryption key and password do not have to be stored on the medium, which provides an enhanced level of protection of the recorded data.

### BACKGROUND

1. Field

One or more embodiments described herein relate to recording information on and reproducing information from a recording medium.

2. Background

A variety of recoding mediums have been developed for storing digital data. A compact disk (CD), for example, has a capacity of about 650 megabytes, a digital versatile disk (DVD) has a capacity of about 4.7 gigabytes, and a Blue-ray disk (BD) has a capacity of about 23 gigabytes. These disks come in rewritable and read-only versions.

FIG. 1 shows a recording medium 10 according to the background art. This medium is divided into a system area 11 and a data area 12, and the data area is divided into a volume structure area 13 and a local volume area 14. A recording medium of this type may used to store encrypted data. The data, however, may only be read and reproduced from the medium using disk drives that are equipped with compatible decryption software.

When a disk drive is unable to identify an encryption scheme of data stored on a recording medium, the drive will either be unable to read the data from the medium or will be unable to decrypt the data even after the data is successfully read. In either instance, the disk drive will erroneously determine that the recording medium is empty, which represents a significant inconvenience to the user.

### BRIEF DESCRIPTION OF THE DRAWINGS

The embodiments will be described in detail with reference to the following drawings in which like reference numerals refer to like elements wherein:

FIG. 1 is a diagram showing the internal structure of a recording medium according to the background art;

FIG. 2 is a diagram showing a recording medium in accordance with one embodiment;

FIG. 3 is a flow diagram showing steps included in a method of recording information on a recording medium according to one embodiment;

FIG. 4 is a flow diagram showing a method of reproducing data from a recording medium according to one embodiment;

FIG. 5A is a diagram showing a physical structure of a recording medium which may be used in accordance with another embodiment, which relates to recording and reproducing information during a multi-session application, and FIG. 5B is a diagram showing a logical structure of the recording medium of FIG. 5A; and

FIG. 6 is a diagram showing an apparatus for recording and reproducing information from a recording medium in accordance with one embodiment.

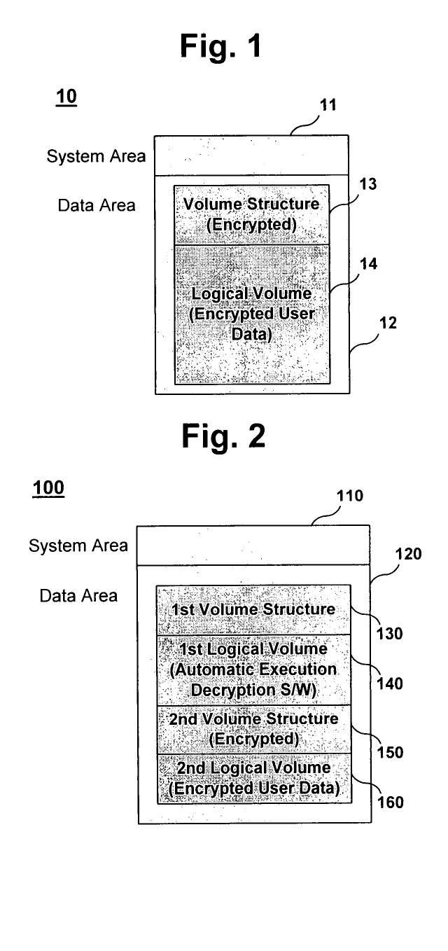

### DETAILED DESCRIPTION

FIG. 2 shows a recording medium according to one embodiment. The medium is divided into a system area 110 and a data area 120. The data area 120 is divided into a first volume structure area 130, a first logical volume area 140, a second volume structure area 150, and a second logical volume area 160.

The first volume structure area 130 is preferably recorded at the head of data area 120 and contains information describing or relating to the contents (e.g., software) recorded in the first logical volume area 140. Area 130 may also include a volume name and/or a header containing location or disk address information for area 140. The information recorded in area 130 may not be encrypted.

The first logical volume area 140 contains automatic execution routine information relating to commands which should be executed when the recording medium is inserted into a device for reproducing data from the recording medium. The first logical volume area may also include decryption software (e.g., a program) which is to be automatically executed based on the automatic execution routine information. Thus, for example, according to one embodiment, unencrypted information may be recorded in first volume structure area 130 and first logical volume area 140. In accordance with the present embodiment, the information in areas 130 and 140 may not be encrypted.

The second volume structure area 150 contains information describing or relating to the contents of area 160. Area 150 may also include a volume name and/or a header containing location or disk address information for area 140. The information in area 150 may or may not be encrypted.

The second logical volume area 160 contains data selected by the user which, for example, may be a file or folder containing video, audio, text, and/or a program. The data stored in area 160 is preferably encrypted using a cryptography scheme such as the Advanced Encryption Standard (AES), which is the current standard encryption algorithm of the USA. Other schemes may also be used such as, for example, SEED of South Korea. The encrypted data in area 160 may be decrypted using the software recorded in area 140.

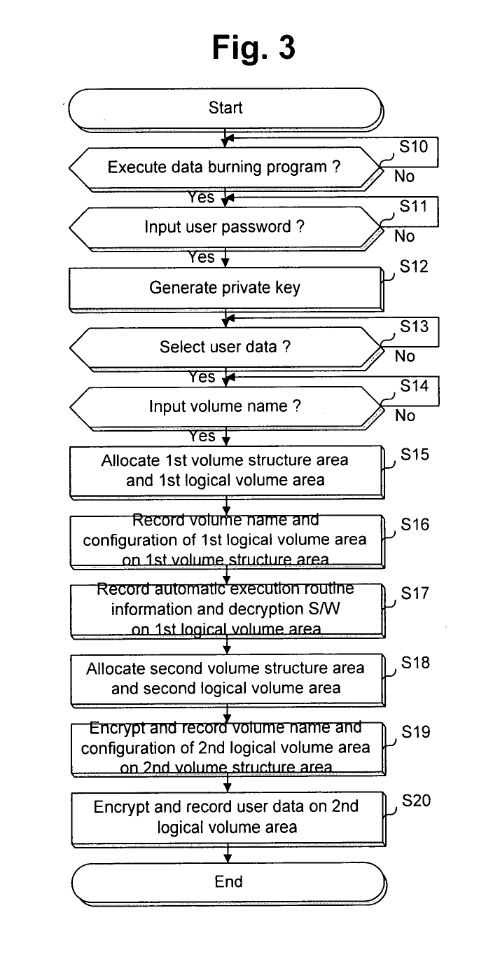

FIG. 3 is a flow diagram showing steps included in a method of recording information on a recording medium according to one embodiment. When data is to be encrypted and recorded on a recording medium inserted into a disk drive of a computer, the method initially records automatic execution routine information and decryption software in first logical volume area 140, preferably located in a front portion of data area 120. The method also records relevant information for the first logical volume area as well as other information (e.g., volume name) in first volume structure area 130. The data selected by the user is then encrypted and recorded in a second logical volume area 160, and information describing this data is recorded in second volume structure area 150.

According to one embodiment, the data recording method may be applied to or implemented by disk drives or data burning programs such as Nero burning. A more specific description of the method will now be provided.

Initially, a user initiates execution of a data burning program, e.g., Nero burning (S10). The data burning program receives a password for purposes of carrying out a user authentication procedure (S11). Upon authentication, the program generates a private key which may serve on an encryption key based on the password input by the user (S12).

Next, the user selects data to be recorded on the medium which, for example, may be a file or folder containing video, audio, text and/or a program (S13). After the data has been designated by the user, the data burning program may allocate the first volume structure area 130 and the first logical volume area 140 in data area 120 of the recording medium (S14). The program then records information relating to (e.g., the type of contents in and/or the configuration of) the first logical volume area 140 in the first volume structure area 130 (S15). Automatic execution routine information and decryption software is recorded in the first logical volume area 140 (S16). The information recorded in areas 130 and 140 are preferably not encrypted.

Next, the data burning program allocates second volume structure area 150 and second logical volume area 160 on the medium. (S17). These areas are preferably allocated after the first logical volume area 140 of the data area 120. The data burning program then records, in the second volume structure area 150, information relating to the contents to be recorded in the second logical volume area 160 (S18). The information recorded in area 150 may or may not be encrypted.

Next, the program encrypts and records, in the second logical volume area 160, the data selected by the user which may be a file or folder containing video, audio, text, and/or program (S19). The encryption of information in area 160 and optionally in area 150 is performed using the private encryption key generated based on the user password.

The data recording method may be used to record data on any one of a variety of disks using any one of a variety of modes, including but not limited to a Disk At Once (DAO) mode on CD-R, CD-RW, DVD-R/+R, DVD-RW/+RW, Blu-ray BD-R, or Blu-ray BD-RW disks. In other words, the data recording method can be adapted to record data in a mode which records and finalizes data on a writable disk.

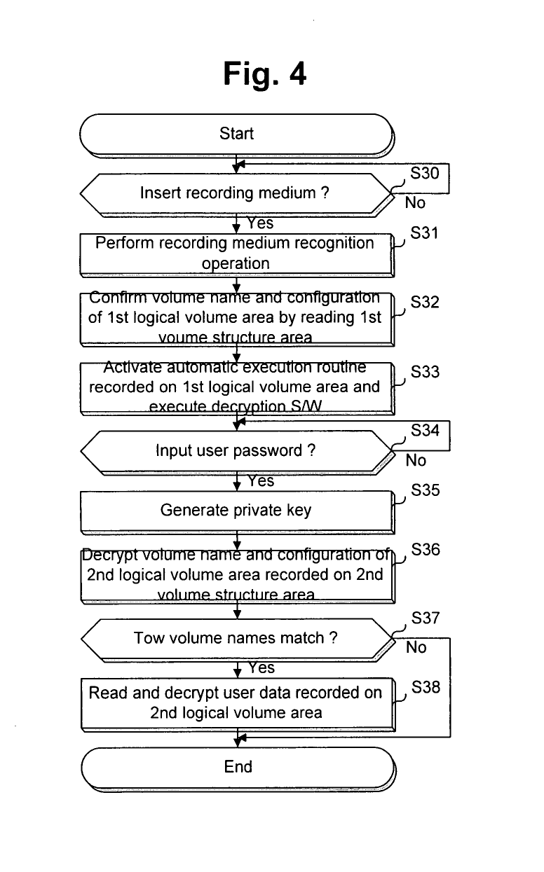

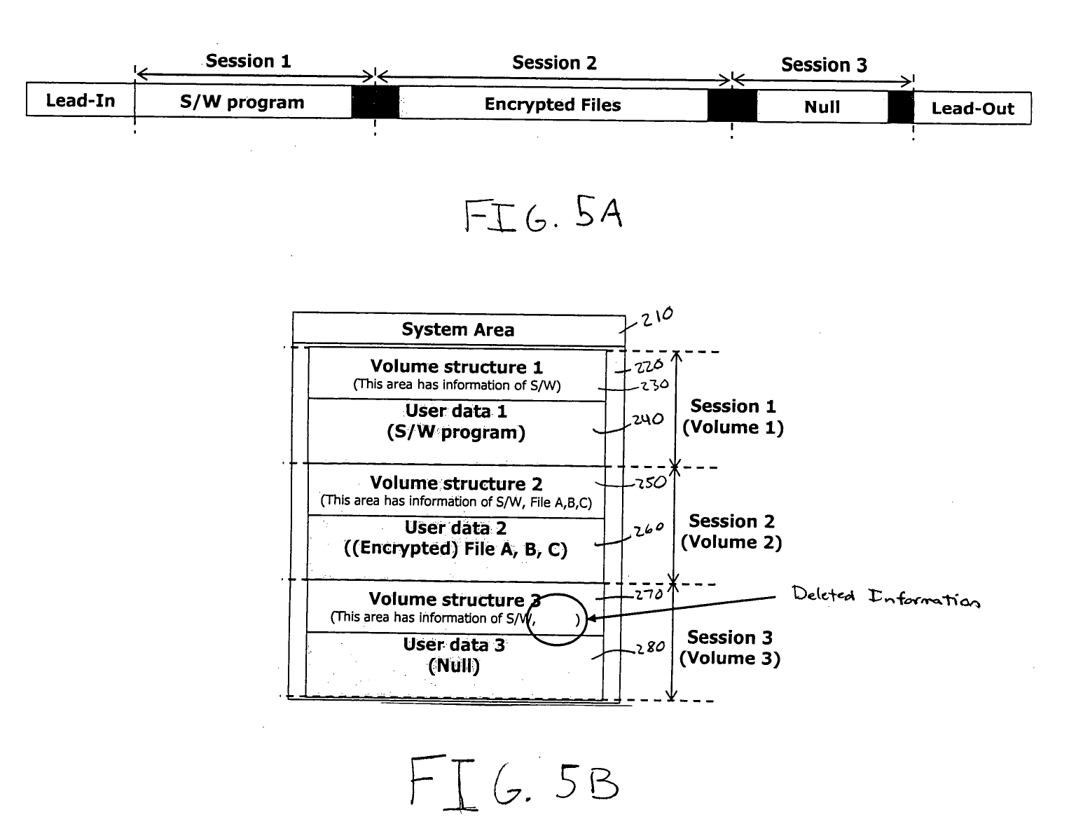

FIG. 4 is a diagram showing steps included in a method for reproducing data read from a medium according to one embodiment. The data may be read by an optical disk drive that is different from the one that recorded the information on the medium. Accordingly, this drive (or its host computer) may not have previously stored decryption software sufficient to read or reproduce all of the information recorded on the medium.

According to this method, when a recording medium is inserted into the disk drive (S30), the drive executes an automatic execution routine recorded on a non-encrypted area of the medium, along with the decryption software which may also be recorded in a non-encrypted area. The decryption software receives the user password, decrypts data in an encrypted area of the medium based on the password, and allows the user to access the decrypted data. The encryption scheme may be one of a variety of encryption schemes such as but not limited to AES or SEED. The non-encrypted area may correspond to areas 130 and 140 and the encrypted area may include area 160 and optionally area 150 as shown in FIG. 2.

More specifically, after the disk drive detects insertion of the recording medium, an operation for recognizing the medium is performed (S31). A volume name recorded in first volume structure area 130 and the content (e.g., automatic execution routine information and decryption software) recorded in the first logical volume area 140 may then be confirmed. Referring to FIG. 2, this confirmation may be performed, for example, by reading information recorded in first volume structure 130 and first logical volume areas 140 allocated in front of data area 120 of the medium 100 (S32). The automatic execution routine recorded in the first logical volume area 140 is then activated and, accordingly, the decryption software is automatically executed (S33).

Next, the executed decryption software carries out a user authentication procedure based on a password input by a user (S34). The software then generates a private encryption key based on the password (S35). Information in the second volume structure area 150 is then decrypted (if necessary) using the private key (S36). This information may, for example, describe the type or configuration of data recorded in second logical volume area 160 using the private key. The user data recorded in the second logical volume area 160 (e.g., a file or folder containing video, audio, text, and/or program) is then read and decrypted using the private key (S37). A decoder in the disk drive then decodes and reproduces the decrypted data.

FIGS. 5A and 5B respectively show physical and logical structures of a recording medium according to another embodiment, which may be used for recording data in a multi-session application. This medium is divided into a system area 210 and a data area 220. The data area 220 is divided into a first volume structure area 230, a first user data area 240, a second volume structure area 250, a second user data area 260, a third volume structure area 270, and a third user data area 280.

The first volume structure area 230 is preferably recorded at the head of data area 220 and contains information describing or relating to contents recorded in the first user data area 240. This information, for example, may describe a type of software recorded in area 130 and/or may include a header with disk address or location information for this area. The information recorded in area 230 may not be encrypted.

The first user data area 240 contains automatic execution routine information relating to commands which should be executed when the recording medium is inserted into a device for reproducing data from the recording medium. The first user data area may also include decryption software (e.g., a program) to be automatically executed based on the automatic execution routine information. The automatic execution routine information and decryption software may be stored in area 240 during a first session (session 1) of a multi-session application in accordance. As shown in FIG. 5A, this information is stored in a section of a larger disk area reserved for storing multi-session data. If desired, user-data may also be stored during this session in area 240. The contents of area 240 may not be encrypted.

The second volume structure area 250 contains information describing or relating to the contents of area 260. Area 250 may also include information describing or otherwise relating to the type software recorded in area 240 and also describes or otherwise relates to the type of data to be recorded in the second user data area 260. The information in area 250 may or may not be encrypted.

The second user data area 260 contains data selected by the user which, for example, may be a file or folder containing video, audio, text, and/or a program. This data may be recorded in area 260 during a second session (session 2) of a multi-session application.

Additionally, the data stored in area 260 is preferably encrypted using a cryptography scheme such as the Advanced Encryption Standard (AES), which is the current standard encryption algorithm of the USA. Other schemes may also be used such as, for example, SEED of South Korea. The encrypted data in area 260 may be decrypted using the software recorded in area 240.

The third volume structure area 270 contains information describing or otherwise relating to the contents (e.g., automatic execution routine information and decryption software) recorded in area 240. This information may also include information which directs a recording head of a disk drive device to read the information stored in this area. The information in the third volume structure area may be recorded in a third session (session 3) of a multi-session application, during which time any information relating to the contents stored in the second user data area is deleted. The third user data area 280 is preferably left to be a null space during session 3.

Because information relating to the contents of the second user data area 260 has been deleted from area 270, a disk drive will not be able to report the data stored in area 260 to a host computer. Consequently, a user will be unable to see the user data in area 26, thereby preserving secrecy of the user data. Also, under these circumstances, the disk drive will only be able to access the contents stored during session 1, because the third user data area is left as a null space and because information relating to the user data in area 260 has been deleted from the third volume structure area 270. The information recorded in areas 270 and 280 may not be encrypted.

In accessing the session 1 information, the disk drive will read the automatic execution routine information and decryption software recorded in area 240. This software will then generate a private encryption key based on a password input by a user, and the user-selected data in area 260 will then be decrypted in the manner previously described in relation to the initial embodiment as shown in FIG. 4.

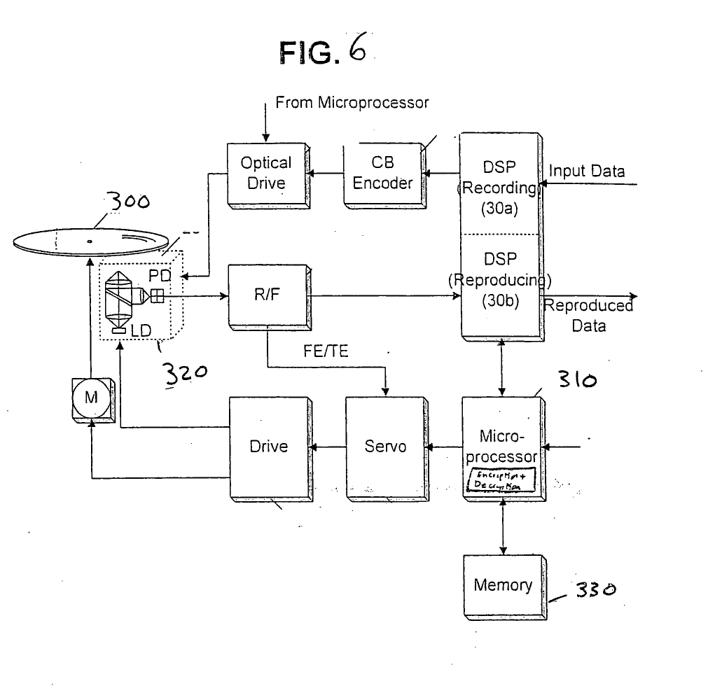

FIG. 6 shows an apparatus for recording information and/or reproducing information from a recording medium 300 in accordance with one embodiment. The apparatus includes a controller 310 to generate an encryption key based on a user password and a recording head 320 to record information (e.g., routines, software, data, description information, etc.) in the areas of a recording medium in accordance with any of the aforementioned embodiments. When recording data on the medium, the controller performs the additional functions of encrypting user-selected data using the encryption key. The recording head then records the encrypted data on the medium.

When reproducing data, the controller generates an encryption key based on a user password. The controller then executes decrypting software which decrypts user-selected data stored on the medium using the key. This apparatus may be used to record and reproduce data and other information from any one of the recording mediums previously described herein.

The embodiments previously discussed may be modified in various ways. For example, instead of using a password to form the encryption keys, one or more values from a network may be used. That is, the private encryption keys used to encrypt and decryption information to be recorded on and reproduced from the recording medium may be generated based on a value derived from a network such as the Internet.

Another embodiment corresponds to a computer-readable medium that controls a processor (e.g., microprocessor 310) to record of information on a recording medium. The computer-readable medium may be stored in a memory 330 and may contain separate code sections for performing the steps of the method and/or the functions of the apparatuses of the embodiments previously described herein.

Thus, at least one embodiment is able to record and reproduce data from a recording medium without having to record and read a user password or private key on the medium. As a result, the user data recorded on the medium is subject to greater protection compared with background-art methods. Additionally, the user's convenience can be enhanced by reproducing encrypted data from the recording medium without requiring separate decryption program, as this program is stored on and read directly from the medium.

While it was previously indicated that the information (e.g., decryption software and automatic execution reactive) stored in areas 130/230 and 140/240 are not encrypted, an alternative embodiment contemplates encrypting this information using a different type or level of encryption from the one used to encrypt the information in areas 150/250 and 160/260. This different type or level of encryption may be compatible with decryption/encryption software previously stored in the disk drive into which the medium is inserted.

In accordance with another embodiment, the recording medium may be a Blu-ray disk (BD) having partitioned areas in accordance with any of the recording mediums previously described. In reproducing data from a BD disk, the method includes generating a private key from parameters generated or received from a playback control engine inside of a BD player. The private key can then be used to decrypt data on the BD disk using a software program that corresponds to a content code read from the BD disk.

In accordance with another embodiment, a method of recording data on a recording medium includes generating an encryption key based on a password input from a user; recording a volume name of the recording medium and information relating to encryption on a first area of a data area of the recording medium; and encrypting and recording the volume name and data selected by the user on a second area of the data area using the encryption key.

In accordance with another embodiment, a method of reproducing data from a recording medium includes reading a first volume name and information relating to encryption from a first area on a data area of the recording medium; and performing a reproduction operation of data recorded on a second area of the data area of the recording medium according to the read information relating to the encryption. The reproduction operation includes generating an encryption key by receiving a password from a user, reading and decrypting a second volume name recorded on the second area based on the encryption key, and reading and decrypting the data recorded on the second area by using an encryption key when the first volume name and the second decrypted volume name match.

The first area and the second area may be respectively split to a certain area where data is recorded and an area where information relating to the data on the certain area and the volume name of the recording medium are recorded.

The information relating to the encryption may include data relating to a routine which is to be automatically executed when the recording medium is inserted to a device for the reproduction, and a program which reads and decrypts the data recorded on the second area. The volume name may be input by the user or generated arbitrarily.

The method may be applied to a device which records the recording medium, or a program which records data on the recording medium by driving the device. Alternatively, the method may be used in a mode which records data on a writable recording medium and finalizes the recording medium.

In accordance with another embodiment, a method for recording information on a medium includes generating an encryption key based on a user password, recording decryption information in a first area of the medium, encrypting user-selected data using the encryption key, and recording the encrypted data in a second area of the medium.

In accordance with another embodiment, a method of reproducing information from a recording medium includes receiving a password from a user, generating an encryption key based on the password, obtaining a decryption program recorded in a first area of the medium, and decrypting user-selected data stored in a second area of the medium using the encryption key generated based on the password.

In accordance with another embodiment, a method for generating a code, comprises receiving program code which is distinctively received from encrypted data, receiving an input, and generating a key code using the received program code based on the received input. The program code may be a content code recorded on Blu-ray disk, which content code may include a decryption program for decrypting data on the disk.

In accordance with another embodiment, a method for decrypting data comprises receiving a program code which is distinctively received from encrypted data, receiving an input, generating a key code using the received program code based on the received input, receiving the encrypted data, and decrypting the encrypted data using the received program code based on the received input.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method for recording information on a medium, comprising:
generating an encryption key based on a user password;
recording decryption information in a first area of the medium;
encrypting user-selected data using the encryption key; and
recording the encrypted data in a second area of the medium.

2. The method of claim 1, wherein the decryption information includes a decryption program for decrypting the user-selected data in the second area.

3. The method of claim 2, wherein the first area further includes an automatic execution routine for automatically controlling a disk drive to execute the decryption program upon insertion of the medium into a disk drive.

4. The method of claim 1, wherein the first area is divided into first and second sub-areas, and wherein the first sub-area records information relating to the decryption information recorded in the second sub-area.

5. The method of claim 4, wherein the second area is divided into third and fourth sub-areas, and wherein the third sub-area records information relating to the encrypted user-selected data recorded in the fourth sub-area.

6. The method of claim 1, wherein the decryption information is not encrypted.

7. The method of claim 1, wherein the user-selected data includes video, audio, text, or a program.

8. The method of claim 1, wherein the medium is a rewritable recording medium.

9. The method of claim 1, wherein the decryption information and encrypted data are recorded during different session of a multi-session application.

10. The method of claim 9, further comprising:
recording information relating to the decryption information recorded in the first area and omitting information relating to the user-selected data stored in the second area.

11. The method of claim 10, wherein the information relating to the decryption information describes a type or configuration of the decryption information stored in the first area.

12. The method of claim 1, wherein the password is not stored on the recording medium.

13. The method of claim 1, wherein the medium is a BD disk and the decryption information is recorded on the BD disk as a content code.

14. A method of reproducing information from a recording medium, comprising:
receiving a password from a user;
generating an encryption key based on the password;
obtaining a decryption program recorded in a first area of the medium; and
decrypting user-selected data stored in a second area of the medium using the encryption key generated based on the password.

15. The method of claim 14, wherein said decrypting includes:
reading an automatic execution routine from the medium,
wherein the routine automatically executes the decryption program in response to insertion of the medium into a disk drive.

16. The method of claim 14, wherein the first area corresponds to a first session area of a multi-session application and the second area corresponds to a second session area of a multi-session application.

17. The method of claim 16, wherein obtaining the decryption program includes:
reading information from a third area on the medium, the third area including information relating to the decryption program recorded in the first area.

18. The method of claim 17, wherein the information in the third area directs a disk drive to obtain the decryption program from the first area.

19. The method of claim 14, wherein the user-selected data includes video, audio, text, or a program.

20. The method of claim 14, wherein the medium is a BD disk and wherein the decryption program is obtained from a content code recorded on the BD disk.

21. An apparatus, comprising:
a controller to generate an encryption key based on a user password; and
a recording circuit to record decryption information in a first area of a recording medium, the controller further encrypting user-selected data using the encryption key and the recording head recording the encrypted data in a second area of the medium.

22. An apparatus, comprising:
a controller to generate an encryption key based on a user password;
a recording head to read a decryption program from a first area of a medium; and
a decrypting circuit to decrypt user-selected data stored in a second area of the medium using the encryption key generated based on the password.

23. A method for generating a code, comprising:
receiving program code which is distinctively received from encrypted data;
receiving an input; and
generating a key code using the received program code based on the received input.

24. A method for decrypting data, comprising:
receiving a program code which is distinctively received from encrypted data;
receiving an input;
generating a key code using the received program code based on the received input;
receiving the encrypted data; and
decrypting the encrypted data using the received program code based on the received input.
